(19) United States
(12) Patent Application Publication
(10) Pub. No.: US 2008/0028669 A1
(43) Pub. Date: Feb. 7, 2008

(54) Insect removal tape, debilitating spray formulation and method for using same

(76) Inventor: Marni Markell Hurwitz, Far Hills, NJ (US)

Correspondence Address: ERNEST D. BUFF;ERNEST D. BUFF AND ASSOCIATES, LLC., 231 SOMERVILLE ROAD, BEDMINSTER, NJ, 07921, US

(21) Appl. No.: 11/894,457

(22) Filed: Aug. 21, 2007

Related U.S. Application Data
(63) Continuation-in-part of application No. 10/849,044, filed on Nov. 15, 2004.
Application No. 10/849,044 is a continuation of application No. 09/737,461, filed on Dec. 18, 2000, now abandoned.

(51) Int. Cl. A01M 1/14; A01M 1/10; A01M 1/20

(52) U.S. Cl. 43/114; 43/132.1; 43/107

(57) ABSTRACT

An insect removal system is provided which includes a chemical insect debilitating agent spray formulation and an insect removal adhesive tape for removing small insects and/or arachnids from a surface. The insect debilitating formulation is composed of an active ingredient that is not harmful to humans or animals so that the formulation can be sprayed on skin or fur surfaces, as well as a plethora of other surfaces. Upon debilitation or killing of the insect, a desired length of the adhesive tape is applied to the insect and surrounding surface so that the insect is covered and adheres to the tape. The tape, with the insect adhered thereto, is then removed from the surface, and is disposed of. Direct contact with the insect during the debilitating and removal processes is avoided.

### CROSS-REFERENCE TO RELATED APPLICATIONS

This application is a continuation-in-part of U.S. application Ser. No.: 10/849,044, filed Nov. 15, 2004, which, in turn, is a continuation of U.S. application Ser. No.: 09/737,461, filed Dec. 18, 2000, now abandoned.

### BACKGROUND OF THE INVENTION

1. Field Of The Invention

The present invention relates to the removal of insects, such as arachnids and ticks from pets, people and nearby surfaces; and more particularly, to an insect removal system wherein a formulation containing an agent that debilitates or kills an insect is applied directly to the insect's body via spray application to a surface such as an animal, person, clothing, wall, or other object where the insect is found, enabling the debilitated insect to be readily removed from the surface by the insect removal tape, and disposed of.

2. Description Of The Prior Art

Small insects and arachnids, such as ticks, fleas, mites, and the like, are known to annoy animals and persons and disturb the public health. Ticks particularly pose special dangers associated with the transmission of diseases to humans and animals, including family pets. Removal of ticks can be difficult and generates risk of regurgitation of blood from the body of the tick into the host's blood stream or breakage of the tick with remnants of the head remaining lodged in the host. Blood transfer from the tick's body resulting from improper removal techniques can be especially dangerous due to the risk of disease transmission.

Known methods for removing ticks, arachnids, and/or insects from animals or persons generally involve extracting the insect or tick with tweezers or fingers, by carefully placing the tweezer prongs at the base of the tick body and quickly pulling the tick from the flesh of the host. Unfortunately, it can be quite difficult to extract an insect from an animal using the tweeze method because this requires the animal to sit still for a prolonged period of time. Extraction may require a person to directly contact the insect with their fingers, which increases the risk of being bitten or stung. Moreover, when attempting to pull an insect, such as a tick, off the surface of the animal, a portion of the tick may still remain embedded in the animal's skin. If the insect is in the home, toxic sprays are undesirable because a large area may be exposed to the spray when only a small insect needs to be immobilized.

Various methods for removal of ticks, arachnids, and/or insects from animals or persons involve the use of sheets having an adhesive thereon. For example, U.S. Pat. No. 2,911,756 to Geary (hereinafter, the '756 patent) discloses an insect combating device comprising a flexible sheet backing, a normally tacky pressure sensitive adhesive united to one surface of the backing, and an insecticidal, insect attracting composition united to the other surface of the backing. The insecticide may be present in amounts ranging from about 0.01 to 5 or 10% by weight in the surface coating, and includes such compounds as demeton, parathion, dimethyl parathion, malathion, or the like, and mixtures thereof; and U.S. Pat. No. 6,185,862 to Nelson (hereinafter, the '862 patent) discloses a device for manually capturing and restraining intended insects, the same comprising a pad of stacked, singular sheets each sheet having a partial enveloping means comprised of hydrophillic absorbing material and collapsible sheet construction whereby the sheet partially conforms in response to the insects body mass for disposal thereof. These insect combatant devices do not provide an insecticide debilitating active ingredient that can be readily applied to a person's skin or an animal's fur, as well as other areas generally in contact with persons and animals, without the risk of exposure to harmful chemicals. In fact, the tacky surface of the '756 patent is not appointed for direct contact with a person's skin, since the agents used present hazards. Although the '862 patent provides for direct removal from a person's skin, there is no disclosure therein concerning an insect debilitating active ingredient. Moreover, these insect combatant devices do not provide an insect debilitating spray appointed to act in conjunction with an insect removal tape device for safe, efficient removal of an insect from a surface.

Other methods of controlling ticks, arachnids, and/or insects involve the use of traps. For example, U.S. Pat. No. 5,896,695 to Walker discloses a box-like device having two halves which are hingedly connected to one another. When opened, the two halves form a pair of trays. An insect entrapping composition within each tray entraps either flying or crawling insects, such as mosquitoes, fleas, ants and the like. A highly reflective foil surrounds a perimeter of each half or tray. The foil may be provided with a luminescent paint to attract the insects. A highly reflective peripheral flange surrounds each tray acts as a mirror surrounding the luminescent paint, thereby further enhancing the attraction. Upon contacting the entrapping composition, the insects are thereupon mired. In an alternative embodiment, each tray is provided with an insect repelling composition to repel insects such as ants. The entrapping composition is not appointed to be sprayed directly on the skin of a person, fur of a pet, or a surface in general. Moreover, a debilitating active ingredient is not provided. A repellant is, instead, added to the entrapping composition. Traps are only effective for the immediate area surrounding the trap. Consequently, the insect navigate to the trap on its own accord before it can be trapped. Further still, the device cannot be utilized for removal of an insect from a person's/animal's body, or other surface.

Devices for emitting vapors of active insecticidal, insect-fugal, or other air-conditioning agents into the air have been proposed in connection with attempts to repel intruding insects. Examples of these types of devices include: U.S. Pat. No. 3,876,762 to Rabussier et al., which discloses a process for the manufacture of a liquid free evaporator device enclosed in an impermeable container wherein a volatile organic liquid evaporates from a container. The organic liquid contains O,O-dimethyl-O-2,2-dichlorovinyl phosphate or an odorant substance selected from the group consisting of a natural essential oil, an individual natural odorant component of a natural essential oil, a synthetic odorant or mixtures thereof. The device is placed in operation by opening and/or removing the container. Chemical agents of camphor, eucalyptus, and phenol are specifically taught for the purpose of creating a composition for air conditioning or cleaning, but not for the purpose of debilitating an insect; and U.S. Pat. No. 6,111,055 to Berger discloses an ester-terminated dimer acid-based polyamide that may be blended with a solvent to form a gel, with a wick appointed therein to form a candle. The solvent may be mineral oil which, in combination with the ester-terminated dimer acid-based polymer, forms a gel. Fragrance material, insecticide, or an insect repellant may be released when the formulation is in use. These vapor emitting devices do not provide an insecticide debilitating active ingredient that can be readily applied to a person's skin or an animal's fur, as well as other areas generally in contact with persons and animals, without the risk of exposure to harmful chemicals. Vapors are utilized to repel insects from entering into the vapor laden area; the vapors do not function to debilitate or kill the insect. Moreover, these vapor emitting devices do not provide an insect debilitating spray appointed to act in conjunction with an insect removal tape device for safe, efficient removal of an insect from a person's/animal's body, as well as other surface commonly encountered by people and animals.

Notwithstanding the efforts of prior art workers to construct devices for dealing with insects, there remains a need in the art for a system and method for removing an insect from a surface that utilizes a spray formulation in conjunction with an insect removal device. There also exists a need in the art for an insect removal system that debilitates or immobilizes the insect through use of a spray formulation composed of active ingredients that are not harmful to humans, animals, or the environment, so that the formulation can be safely sprayed directly on a person's or animal's body, and areas encountered by same. Moreover, there remains a need in the art for an insect removal tape that is utilized in conjunction with a non-hazardous spray formulation to effectively remove the debilitated or immobilized insect from the surface while avoiding direct contact therewith.

### SUMMARY OF THE INVENTION

The present invention provides an insect removal system and method for removing an insect from a surface that utilizes a spray formulation in conjunction with an insect removal device. Debilitation and immobilization of the insect occurs when a formulation containing an insect debilitating active ingredient is sprayed onto the body of the insect and the surrounding surface. Spraying of the formulation directly onto the skin or fur is not hazardous to the person or animal because the active ingredients utilized in the formulation are safe for humans, animals, and the environment. Upon contact of the active ingredient, the insect becomes immobilized or dies. Immediately following contact with the active ingredient, an insect removal device including a tape having a first side with an adhesive is applied to the insect and adheres thereto. The tape, with the insect thereon adhered, can thereafter be readily discarded.

The insect removal system comprises an insect debilitating formulation composed of an active ingredient that is appointed to be applied to an insect located on a surface. The active ingredient within the formulation substantially debilitates or kills the insect soon after contact therewith. The system further comprises a tape having a first side with an adhesive layer thereon to facilitate sticking of the tape to the surface and the debilitated insect. Additionally, the tape further includes a second side, which is not sticky. The non-sticky side facilitates application of the tape to the surface and the debilitated insect by hand, and subsequent removal of the tape from the surface, with the debilitated insect adhered thereto. Removal of the insect utilizing the subject system virtually eliminates unnecessary contact between the person performing the removal and the insect. The system has particular applications in the removal of ticks from a person or animal in a safe, convenient manner, minimizing potential risks associated with removal of such arachnids.

An insect debilitating formulation is also provided. The debilitating formulation is appointed to be applied to an insect located on a surface in order to debilitate or kill the insect. The formulation comprises an active ingredient composed of eucalyptus oil. Alternatively, the active ingredient of the insect debilitating formulation comprises camphor, phenol and light mineral oil. The active ingredient may include camphor ranging from 9 to 12 weight percent, phenol ranging from 3 to 6 weight percent, eucalyptus oil ranging from 10 to 70 weight percent, and a light mineral oil ranging from 7 to 12 weight percent.

A method for removing an insect from a surface is provided comprising the first step of substantially saturating an insect located on a surface with an insect debilitating formulation housed in a container. The insect debilitating formulation comprises an active ingredient that debilitates or kills the insect upon contact or in close proximity thereof. Next, after the insect is debilitated or otherwise immobilized, a piece of insect removal tape is tom from a dispensing device and is positioned to be placed upon the debilitated insect. The insect removal tape comprises a first side having an adhesive layer thereon. The first side of the tape is placed in contact with the debilitated insect so that the insect adheres to the first side of the tape. A second, non-sticky side of the tape is provided for efficient handling of the tape. Peeling the insect removal tape from the surface with the insect adhered thereto results in removal of the insect from the body or surface. Lastly, the tape piece with the insect adhered thereto is folded in half so that the insect is disposed inside the folded tape and the tape and insect are disposed of.

### BRIEF DESCRIPTION OF THE DRAWINGS

The invention will be more fully understood and further advantages will become apparent when reference is had to the following detailed description of the preferred embodiments of the invention and the accompanying drawings, in which:

FIG. 1a is a perspective view of a tick located on a person's arm and an insect debilitating formulation comprising an active ingredient that is applied by way of a spray container onto the tick and locale surface of the arm;

FIG. 1b is a perspective view of the tick substantially saturated in the insect debilitating formulation comprising the active ingredient, with the tick becoming debilitated or otherwise immobilized;

FIG. 1c is a perspective view of a tape dispenser having a spool of the insect removal tape thereon, with a piece of the tape being appointed to be torn off for application to the debilitated tick for removal and disposition thereof;

FIG. 1d is a perspective view of the tape piece being applied to the debilitated tick so that the tick can be removed from the arm and disposed of;

FIG. 2 is a perspective view of an embodiment of the optional handheld roller for dispensing the insect removal tape, with a spray container housing the insect debilitating formulation removably retained within the spool or roller portion for convenient access;

FIG. 3 is a detailed view of the insect removal tape;

FIG. 4 is a perspective view of the insect removal tape after removing an insect;

FIG. 5 is a perspective view of another embodiment of a handheld roller, with a spray container housing the insect debilitating formulation removably retained within the handle portion for convenient access; and

FIG. 6 is a perspective view of a roll of tape appointed for disposition on the handheld roller of FIG. 5.

### DETAILED DESCRIPTION OF THE INVENTION

The present invention provides an insect removal system for removing an insect or arachnid, particularly a tick, from a surface, and method for using same. Active ingredients used in the insect debilitating formulation are safe for application to humans and pets, and are environmentally safe for use on a plethora of surfaces. Debilitation and immobilization of the insect occurs as a formulation containing an insect debilitating active ingredient is sprayed onto the body of the insect and the surrounding surface. Spraying of the formulation directly onto skin or fur is not hazardous to the person or animal because the active ingredients utilized in composing the formulation are safe for humans, animals, and the environment. Upon contact of the active ingredient, the insect becomes immobilized or dies. Immediately following contact with the active ingredient, an insect removal device including a tape having a first side with an adhesive is applied to the insect and adheres thereto. The tape, with the insect thereon adhered is then readily discarded.

The present invention was conceived in response to the invasion of the tick insect, or any other small insect that annoys and disturbs the public health. With the present invention, the insect is immobilized on the surface of the animal, person or inanimate object upon contact with the insect debilitating formulation that is sprayed thereon. Upon debilitation, the insect is removed from the surface by way of the insect removal tape having an adhesive first side, which is applied so that the insect sticks to the tape. In addition, the tape itself may further be provided with a supplemental agent that acts to further debilitate and/or kill the insect. Only a small amount of the agent is necessary to affect the insect and achieve the objective of the invention.

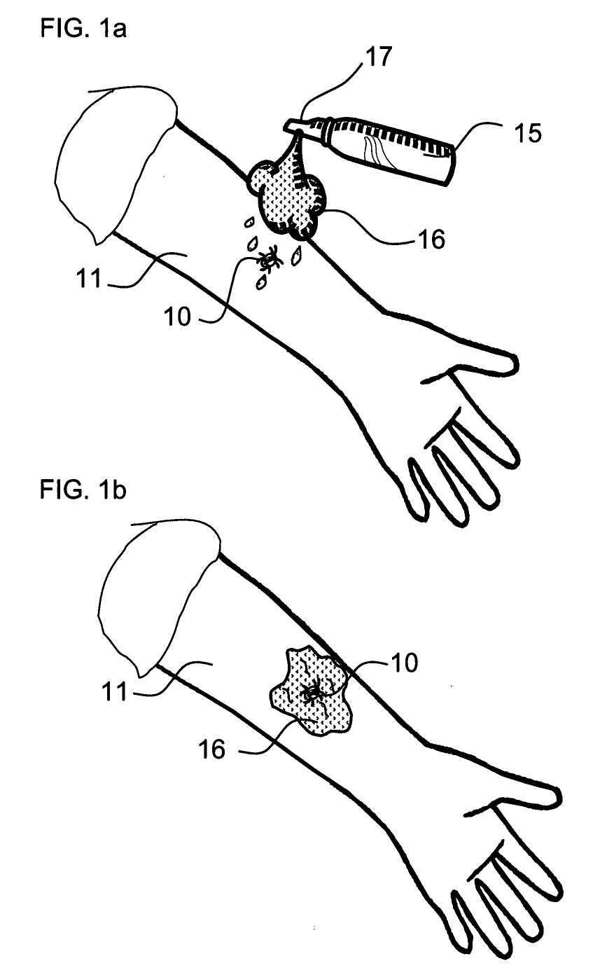

FIGS. 1a-1d show perspective views of the system as applied for removal of a tick from a person's arm. Referring to FIGS. 1a and 1b, a tick 10 is located on a person's arm 11. An insect debilitating formulation 16 is sprayed onto tick 10 by way of a spray container 15. Insect debilitating formulation 16 comprises an active ingredient that is environmentally non-hazardous, and is safe to be applied to a person, animal, or other surfaces. The active ingredient is not a chemical pesticide and is safe for animals and children, i.e., people friendly. Eucalyptus oil may be utilized as the active ingredient in making-up the insect debilitating formulation. Alternatively, the active ingredients making-up the insect debilitating formulation comprise camphor, phenol, eucalyptus oil, and light mineral oil. Ranges may include: camphor from 9 to 12 weight percent, phenol from 3 to 6 weight percent, eucalyptus oil from 10 to 70 weight percent, and a light mineral oil from 7 to 12 weight percent. Preferably, the formulation includes camphor 10.8%, phenol 4.7%, eucalyptus oil 10-70% and light mineral oil ˜10%. The above ingredients may be used singularly or in combination with each other. Alternatively, an alcohol may be provided as the active ingredient, mixed with inactive ingredients. The alcohol content may range from 10 to 70 weight percent. Preferably, the alcohol is in the range of 20-60%. Inactive ingredients may include at least one of: denatonium benzoate, denatonium saccharide, R-methyl, R-isobutyl, R-ketone, and water. Alternatively, the formulation may be a mixture comprising menthol, camphor and eucalyptus oil. Menthol may range from 1.5 to 3 weight percent, camphor may range from 3 to 6 weight percent and eucalyptus oil may range from 0.5 to 3 weight percent. Preferably, the mixture contains menthol 2.6%, camphor 4.8% and eucalyptus oil 1.2%. The insect debilitating formulation may further comprise at least one of: topical analgesics, cedar leaf oil, nutmeg oil, petroleum, or thymol. Insect debilitating formulation 16 is contained in container 15 appointed with a spray mechanism 17 so that formulation 16 is sprayed onto tick 10 and surface/arm 11 and substantially saturates tick 10 and debilitates or kills same. Upon application of insect debilitating formulation 16, tick 10 becomes substantially saturated and becomes debilitated or otherwise immobilized. Because the formulation 16 is non-hazardous, application to the arm 11 area surrounding tick 10 does not pose health risks.

Referring to FIG. 1c a tape dispenser 6 is shown with a spool 5 of insect removal tape 1. Dispenser 6 has a portion 6a for dispensing an end of the tape 1. A serrated blade 6b may be provided for cutting the tape so that a desired length of tape 1 is dispensed from the spool 5. Dispenser 6 may be designed in a number of shapes and colors, and may be tooled to resemble a particular animal, such as a cat, dog, or the like. Dispenser 6 may be designed to have a portion 6c which will clip onto a belt or pocket, so that the operator can devote both hands to tearing off the tape and applying the tape to the surface. This hands-free operation is particularly important when the tape is being applied to an animal and one hand is needed to hold the animal still. Referring to FIG. 1d, after the desired length of tape 1 is separated from spool 5 the first side with the adhesive is placed on tick 10 and the surrounding formulation 16. The piece of tape 1 is then removed from arm 1, at the same time removing tick 10 from arm 11.

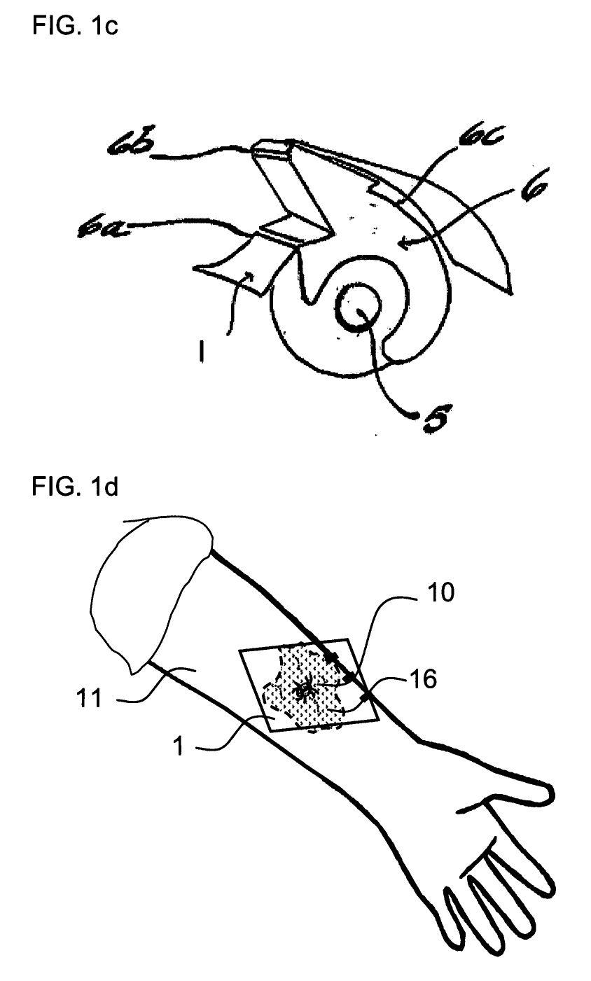

FIG. 2 illustrates an alternative device for dispensing the insect removal tape 1, with a spray container housing the insect debilitating formulation removably retained within the spool for convenient access. Handheld roller 7 holds spool 5 of tape 1. A convenient handle 7a is provided so that the insect removal tape 1 can easily be unrolled and applied to the desired surface. The handle 7a may vary in texture and size and may be contoured for hand comfort. The dispenser 6 and handheld roller 7 may be designed so that a refill roll of tape can be accommodated thereon when the current roll of tape is used up. A spray container 20 housing insect debilitating formulation 21 is removably retained within an interior compartment 19 of spool 5 for convenient access to insect debilitating formulation 21. Container 20 preferably includes an exterior tab 22 for easy removable of container 30 from interior compartment 19 of spool 5. In this manner, a user has immediate access to the insect debilitating formulation 21 for debilitating the insect.

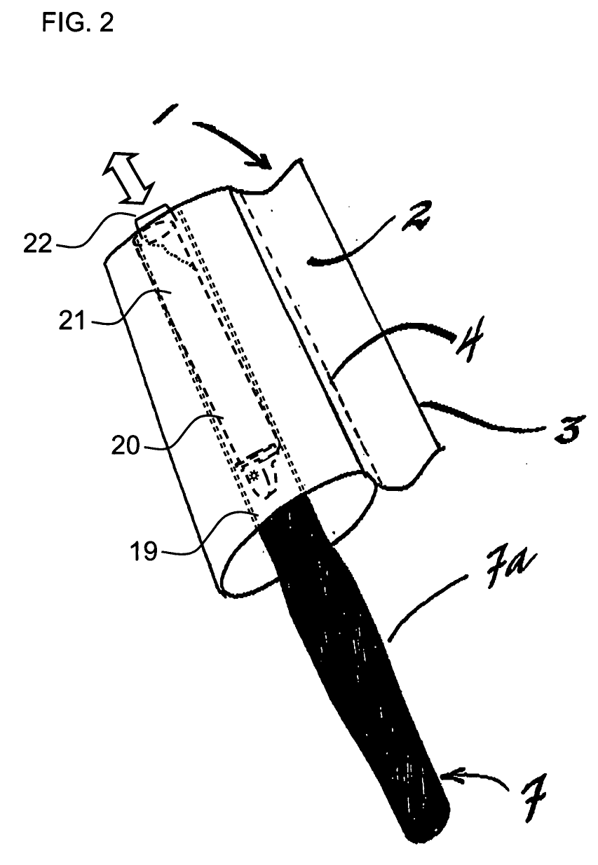

FIG. 3 illustrates the insect removal tape 1. A first side 2 of the tape has an adhesive applied thereto, to facilitate the sticking of the tape to the animal's surface and the insect. The stickiness of the adhesive also serves to immobilize the insect. The second side 3 of the tape is not sticky, to allow for easy handling of the tape. In an alternative embodiment, the adhesive layer of first side 2 of insect removal tape 1 further comprises a tape active ingredient for debilitating the insect supplemental to the insect debilitating formulation of the spray container. The alternative tape active ingredient may cover the entire surface of the adhesive side of the tape, or it may only be present on a portion of the surface of the tape. For instance, the active ingredient may be provided only along the perimeter edges of the tape. Moreover, the active ingredient may be layered over the adhesive, under the adhesive or embedded in the adhesive material. Tape 1 may have perforations 4 to facilitate easy tearing of the tape from the dispenser. However, this is not necessary since any means for cutting the tape may be used, such as scissors, etc. The preferable width “w” of the tape is approximately 2″. However, other sizes may be utilized if a smaller or larger area needs to be tended to. Although the tape may be any color, light colored or clear tape allows for easy visibility of the surface and the insect after the tape has been applied to the surface.

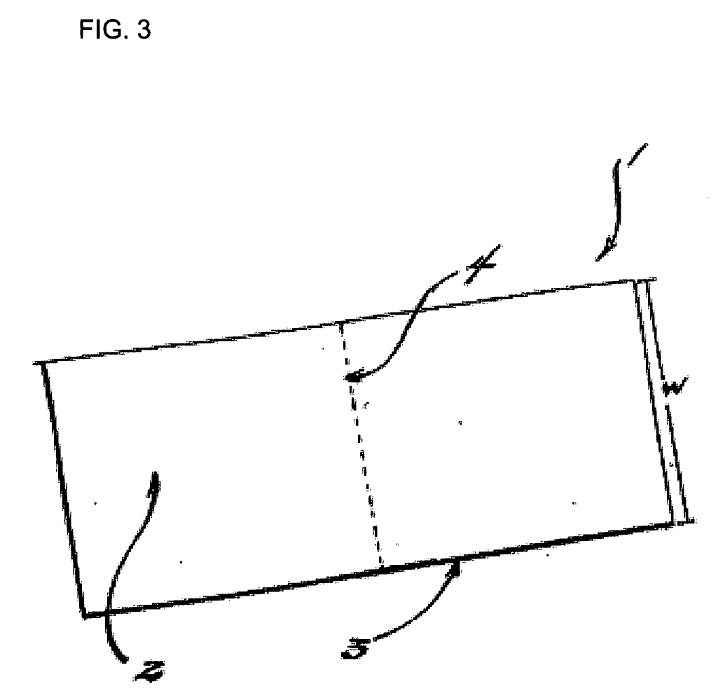

With the present invention, one does not have to touch the insect or risk getting bitten. The tape 1 can be easily removed from the surface and folded in half so that the insect is disposed on the inside of the tape, as illustrated in FIG. 4. The insect is completely covered and the tape can easily be discarded without risk. Specifically, according to a method of using the present invention, a desired amount of tape 1 is adhered to a surface, such as the surface of an animal which has an insect disposed thereon. The tape is applied so that the debilitated insect contacts the tape. The adhesive side of the tape should face the insect for removal thereof. The tape is then folded in half so that the insect is disposed within the folded tape.

The handheld roller 7 may be used in several ways. For instance, the roller may be pressed against a surface and rolled along the surface so that any insects on the surface immediately stick to the tape while it is still wound on the roller. With this use, the tape is then removed from the roller with the insect attached thereto. As discussed above, the insect formulation container may be stored in the spool 5 of the roller for ready access thereto for debilitation of the insect. In another use, the roller may be pressed against a surface and rolled along the surface so that the tape unrolls from the roller and sticks to the surface. A predetermined amount of tape is torn or cut off from the supply of tape on the handheld roller. Here, the tape is removed from the roller similar to the use of the dispenser 1 discussed above. In this case, the tape is removed from the surface after the tick has adhered to the tape. The handheld roller can also be used so that the tape remains on the roller. Here, the insect removal tape remains on the handheld roller and the insects are rinsed off the tape while the tape remains on the roller.

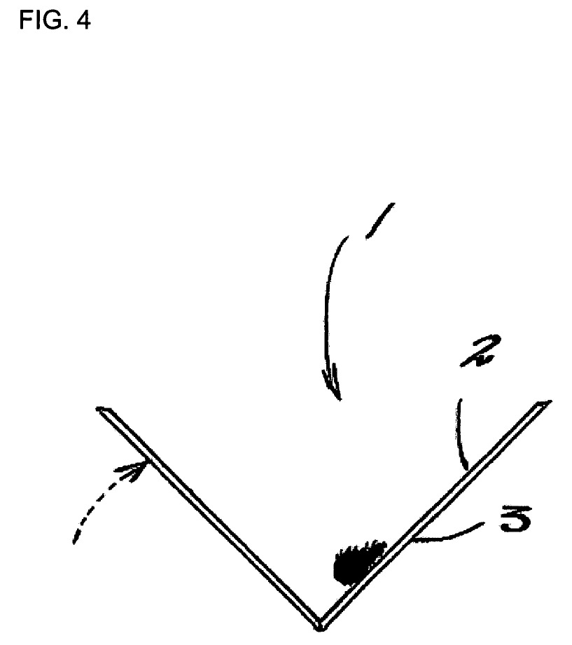

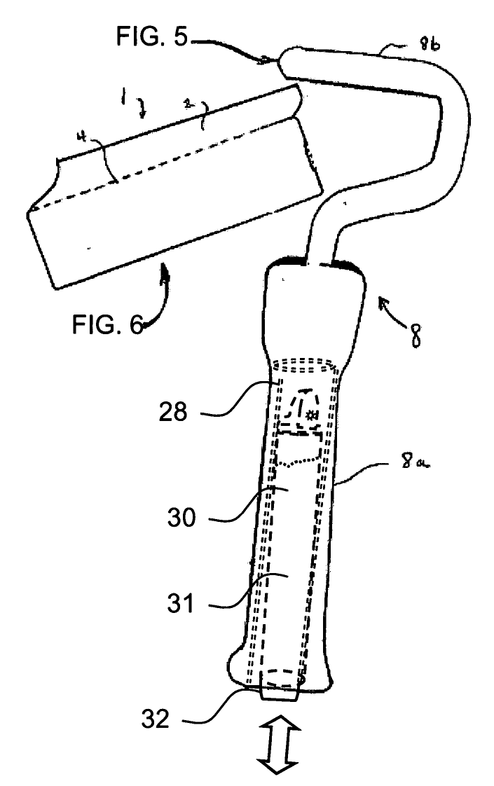

FIGS. 5 and 6 illustrate another type of handheld roller wherein a spray container housing the insect debilitating formulation is removably retained within the handle portion for convenient access. Specifically, a handheld roller 8 is provided with a handle 8a having a longitudinal axis which is perpendicular to the longitudinal axis of the spool of tape. Handle 8a may include an interior handle cavity 28 for housing a container 30 retaining insect debilitating formulation 31. Container 30 preferably includes an exterior tab 32 for easy removal of container 30 from handle cavity 28. A spool with insect removal tape is designed to be disposed on the handheld roller 8, as illustrated in FIG. 6. This handheld roller embodiment allows the tape to be rolled onto a surface in a vertical motion. As illustrated by FIG. 6, refill spools of tape can be easily loaded onto a rotating spindle 8a of the handheld roller 8 as needed. The handle 8a may include various textures and sizes, as well as contours, to provide a comfortable grip. As with the handheld roller 7, the handheld roller 8 can be used in the different ways discussed above. For example, the tape can remain on the roller and the insect rinsed off the tape, which would allow the tape to be reused. Alternatively, the tape can be removed from roller after the insect has adhered to the tape. Also, the tape can be unwound from the roller as the roller is pressed against the surface having the insect. With the present invention a large surface area can be covered in only a few seconds. Thus, insects can be removed quickly and easily with little effort since the insect is debilitated by way of the spray formulation and then securely sealed to the adhesive surface.

The present invention is intended to include any type of device having an adhesive quality that is capable of immobilizing or killing an insect. Such devices include rubberized adhesive rollers, or other comparable roller-type devices which have an adhesive or tacky surface which is capable of immobilizing an insect. Thus, tape does not have to be used since any device, e.g., a roller, can be provided with an adhesive quality that would be capable of immobilizing or killing an insect. Instead of tearing away the tape to discard the insect, the adhesive roller or similar device can simply be rinsed in order to discard the attached insect. With this type of rubberized adhesive surface, or any other type of reusable surface, a low cost and environmentally friendly alternative is possible since the same adhesive surface is reused again and again. Of course, the reusable rubberized adhesive roller or similar device can be used in either of the handheld rollers disclosed above or equivalents thereof. Also, the present invention is intended to include other chemical solutions in addition to those described above. Any chemical solutions which are formed of the phenol group, for example, could be used in the solution.

Spray application of the insect debilitating formula allows for direct, controlled application and broad application to hard to reach areas. Preferably, the spray container includes an adjustable nozzle, allowing enhanced control in delivery of the formulation to the given surface. An insect debilitating formulation is also provided that may be utilized alone or in conjunction with the insect removal tape. In one embodiment, the formulation comprises eucalyptus oil as the active ingredient. Alternatively, the insect debilitating formulation comprises camphor, phenol and light mineral oil. The formulation is safe for contact for humans and pets, and can be applied over clothing or fabrics to debilitate insects thereon, or can be used as a repellant. Moreover, the formulation can be sprayed on furniture, camping gear, or anything where insects may pose a problem, without causing adverse health effects to persons or animals.

Having thus described the invention in rather full detail, it will be understood that such detail need not be strictly adhered to, but that additional changes and modifications may suggest themselves to one skilled in the art, all falling within the scope of the invention as defined by the subjoined claims.

What is claimed is:

1. An insect removal system, comprising
a. an insect debilitating formulation comprising an active ingredient appointed to be applied to said insect located on a surface in order to debilitate or kill said insect;
b. a tape having a first side including an adhesive layer thereon to facilitate sticking of said tape to said surface and said debilitated insect; and
c. said tape further having a second side which is not sticky, to permit application of said tape to said surface and said debilitated insect by hand, and subsequent removal of said tape with said debilitated insect adhered thereto, from said surface.

2. An insect removal system as recited by claim 1, wherein said insect removal tape has perforations for facilitating tearing off a portion of said tape.

3. An insect removal system as recited by claim 1, wherein said insect removal tape is wound on a spool which is disposed on a dispenser.

4. An insect removal system as recited by claim 3, wherein said dispenser is a handheld roller.

5. An insect removal system as recited by claim 1, wherein said adhesive layer of said first side of said insect removal tape further comprises an active ingredient for debilitating said insect supplemental to said insect debilitating formulation.

6. An insect removal system as recited by claim 1, wherein said active ingredient of said insect debilitating formulation comprises eucalyptus oil.

7. An insect removal system as recited by claim 1, wherein said active ingredient of said insect debilitating formulation comprises camphor, phenol, eucalyptus oil, and light mineral oil.

8. An insect removal system as recited by claim 7, wherein said active ingredient comprises camphor ranging from 9 to 12 weight percent, phenol ranging from 3 to 6 weight percent, eucalyptus oil ranging from 10 to 70 weight percent, and a light mineral oil ranging from 7 to 12 weight percent.

9. An insect removal system as recited by claim 1, wherein said active ingredient of said insect debilitating formulation comprises an alcohol mixed with inactive ingredients, said alcohol ranging from 20 to 60 weight percent.

10. An insect removal system as recited by claim 9, wherein said inactive ingredients include at least one of: denatonium benzoate, denatonium saccharide, R-methyl, R-isobutyl, R-ketone, and water.

11. An insect removal system as recited by claim 1, wherein said active ingredient of said insect debilitating formulation comprises inactive ingredients including at least one of: denatonium benzoate, denatonium saccharide, R-methyl, R-isobutyl, R-ketone, and water.

12. An insect removal system as recited by claim 1, wherein said active ingredient of said insect debilitating formulation comprises menthol, camphor and eucalyptus oil.

13. An insect removal system as recited by claim 12, wherein said active ingredient comprises menthol ranging from 1.5 to 3 weight percent, camphor ranging from 3 to 6 weight percent and eucalyptus oil ranging from 0.5 to 3 weight percent.

14. An insect removal solution as recited by claim 1, wherein said active ingredient of said insect debilitating formulation further comprises at least one of: topical analgesics, cedar leaf oil, nutmeg oil, petroleum, or thymol.

15. An insect removal solution as recited by claim 1, wherein said insect debilitating formulation is contained in a container appointed with a spray mechanism so that said formulation is sprayed onto said insect and said surface and substantially saturates said insect and debilitates or kills same.

16. An insect removal system as recited by claim 15, wherein said insect removal tape is wound on a spool which is disposed on a dispenser and wherein said spool includes an interior cavity appointed to removably receive and house said container with said insect debilitating formulation contained therein.

17. An insect removal system as recited by claim 15, wherein said insect removal tape is wound on a spool which is disposed on a dispenser constructed as a handheld roller, and wherein said handheld roller includes a handle having a handle cavity appointed to removably receive and house said container with said insect debilitating formulation contained therein.

18. An insect debilitating formulation appointed to be applied to an insect located on a surface in order to debilitate or kill said insect, comprising an active ingredient composed of eucalyptus oil.

19. An insect debilitating formulation as recited by claim 18, wherein said active ingredient of said insect debilitating formulation comprises camphor, phenol and light mineral oil.

20. An insect debilitating formulation as recited by claim 18, wherein said active ingredient comprises camphor ranging from 9 to 12 weight percent, phenol ranging from 3 to 6 weight percent, eucalyptus oil ranging from 10 to 70 weight percent, and a light mineral oil ranging from 7 to 12 weight percent.

21. A method for removing an insect from a surface, comprising the steps of:
a. substantially saturating said insect and said surface with an insect debilitating formulation housed in a container, said insect debilitating formulation comprising a active ingredient in order to debilitate or kill said insect;
b. placing a piece of insect removal tape comprising a first side including an adhesive layer thereon on said debilitated insect and said surface so that said first side of said tape contacts said insect and said insect adheres to said adhesive layer of said first side, said tape further comprising a second side which is not sticky;
c. peeling said insect removal tape from said surface with said insect adhered to said first side of said tape;
d. folding said piece of said tape in half so that said insect is disposed inside said folded tape; and
e. discarding said folded piece of tape with said debilitated insect disposed therein.

22. A method for removing an insect from a surface as recited by claim 21, wherein said active ingredient of said insect debilitating formulation comprises camphor, phenol, eucalyptus oil, and light mineral oil.

23. A method for removing an insect from a surface as recited by claim 21, wherein said active ingredient of said insect debilitating formulation comprises an alcohol mixed with inactive ingredients, said alcohol ranging from 20 to 60 weight percent.

24. A method for removing an insect from a surface as recited by claim 21, wherein said active ingredient of said insect debilitating formulation comprises menthol, camphor and eucalyptus oil.

25. A method for removing an insect from a surface as recited by claim 21, wherein said active ingredient of said insect debilitating formulation further comprises at least one of: topical analgesics, cedar leaf oil, nutmeg oil, petroleum, or thymol.

26. A method for removing an insect from a surface as recited by claim 21, wherein said insect removal tape is wound on a spool which is disposed on a dispenser having a handle and a roller portion, and wherein said dispenser includes a cavity appointed to removably receive and house said container with said insect debilitating formulation contained therein.
